(19) United States
(12) Patent Application Publication
(10) Pub. No.: US 2011/0223280 A1
(43) Pub. Date: Sep. 15, 2011

(54) Basic Water

(76) Inventor: Dany Wachter, Lachen (CH)

(21) Appl. No.: 13/044,812

(22) Filed: Mar. 10, 2011

(30) Foreign Application Priority Data
Mar. 11, 2010 (EP) 10405051.3

(51) Int. Cl. A23L 2/00

(52) U.S. Cl. 426/2; 426/66

(57) ABSTRACT

The basic water can, for example, be used as a de-acidification drink and/or as a pH-stabilizing medium. The lye is preferably manufactured with an electrolysis method or with a membrane electrolysis method. Caustic soda lye (NaOH), caustic potash lye (KOH), or calcium hydroxide solution (Ca(OH)₂) but also other lyes are suitable as the lye. The water can, for example, be drinking water, table water, spring water, mineral water, melt water, rain water, well water, ground water, tap water, osmosis water, and/or spa water or medicinal water. Aroma substances and/or colorings can be admixed to the basic water. The basic water can, for example, be used as a food, or as a high-value food supplement, as a mineralization medium, as a drink, or as a detoxification medium, as a hydration medium, as a mineralization medium, or as a de-acidification medium for humans and animals. Tensides can be admixed to the basic water, for example for applications as a spray medium for plants and other applications in agriculture, or for the dilution of other tensides which then become more environmentally friendly and less dangerous, that is to say that the basic water can form a foundation or basis for tensides. The basic water can be used as a foundation for any tenside production, without normal water being added. The basic water can be used as a primary product for other products which reduce the surface tension.

The invention relates to the manufacture of a basic water in accordance with the preamble of claim 1, and also to the use of the basic water made in accordance with the method.

Basic water is practically unknown in nature. One of the reasons for this is that basic waters are not stable. To date one also does not know any method of manufacturing stable basic water. It would, however, be desirable to have a stable basic water available. The method of the invention enables the manufacture of a stable basic water. The method has the features of the independent claim 1. The dependent claims relate to advantageous embodiments of the invention.

Drinking water, table water, spring water, mineral water, melt water, rain water, tap water, osmosis water, well water, ground water, and spa water or medicinal water, are suitable as water for the manufacture of the basic Having a pH value of 7 to 14, preferably pH 9 to 10, which is preferably manufactured by a membrane electrolysis method or an electrolysis method is admixed to the water. The basic water which is manufactured in accordance with the method of the invention is chemically stable. The basic primary solution for other chemically based solutions, for example a cationic primary solution for health baths in the wellness area, which are based on lyes, or as a cationic primary product for the production of products based on tensides.

The basic water is mixed with tenside. Such basic water with a lower content of tenside is at least as effective or more effective than a mixture of non-basic water and tenside. The saving of tenside thus also results with an improved action. Tensides serve for the reduction of the surface tension of liquids, in our case the basic water aids and promotes the reduction of the surface tension. Chemically based tensides can be reduced and can be diluted with the basic water. The positive ions are activated or selected and thus a basic water which has an alkaline pH value as a primary substance, but nevertheless retains and has water-like properties and as such remains stable. The presence of NaOH is a side effect which is, however, chemically mentioned since for an ideal ion activation/selection in the throughflow system conductors are needed, such as sodium chloride or similar products. The primary substance water contains positive and negative ions. The idea of the invention is to select and activate the positive ions. These selected positive ions are primary product/platform and then different “accelerators” can be added which give the product stronger properties. The stability is increased. Waters with pH stabilizers make these waters to a primary substance for humans and animals. Primary substances for the development of purification media etc. contain other concentrations or other stabilizers. The selected ions have water-like properties and are distinguished, for example, from caustic soda lye or other lyes. The basic water is thereby manufactured from a mixture of lye and water and is chemically stable.

The basic water can, for example, be used as a de-acidification drink and/or as a pH-stabilizing medium. The lye is preferably manufactured with an electrolysis method or with a membrane electrolysis method. Caustic soda lye (NaOH), caustic potash lye (KOH), or calcium hydroxide solution (Ca(OH)₂) are suitable as lyes. The water can, for example, be admixed with drinking water, table water, spring water, mineral water, melt water, rain water, tap water, osmosis water, and/or spa water or medicinal water. Aroma substances and/or colorings can be mixed to the basic water.

The basic water can, for example, be used as a foodstuff, or as a high-value food supplement, as a mineralization medium, as a drink, or as a detoxification medium, as a hydration medium, as a mineralization medium, or as a de-acidification medium for humans and animals.

The basic water is manufactured from a mixture of lye and water and is chemically stable. The basic water can, for example, be used as a de-acidification drink and/or as a pH stabilization medium. The is preferably manufactured with an electrolysis method, or with a membrane electrolysis method. Caustic soda lye (NaOH), caustic potash lye (KOH), or calcium hydroxide solution (Ca(OH)₂), but also other lyes are suitable as lyes. The water can, for example, be drinking water, table water, spring water, mineral water, melt water, rain water, tap water, osmosis water, and/or spa water or medicinal water. Aroma substances and/or colorings can be admixed to the basic water.

The basic water can, for example, be used as a foodstuff, or as a high-value food supplement, as a mineralization medium, as a drink, or as a detoxification medium, as a hydration medium, as a mineralization medium, or as a de-acidification medium for humans and animals.

The basic water is manufactured from a mixture of lye and water and is chemically stable.

The basic water can, for example, be used as a de-acidification drink and/or as a pH-stabilizing medium. The lye is preferably manufactured with an electrolysis method or with a membrane electrolysis method. Caustic soda lye (NaOH), caustic potash lye (KOH), or calcium hydroxide solution (Ca(OH)₂) but also other lyes are suitable as the lye. The water can, for example, be drinking water, table water, spring water, mineral water, melt water, rain water, well water, ground water, tap water, osmosis water, and/or spa water or medicinal water. Aroma substances and/or colorings can be admixed to the basic water. The basic water can, for example, be used as a food, or as a high-value food supplement, as a mineralization medium, as a drink, or as a detoxification medium, as a hydration medium, as a mineralization medium, or as a de-acidification medium for humans and animals. Tensides can be admixed to the basic water, for example for applications as a spray medium for plants and other applications in agriculture, or for the dilution of other tensides which then become more environmentally friendly and less dangerous, that is to say that the basic water can form a foundation or basis for tensides. The basic water can be used as a foundation for any tenside production, without normal water being added. The basic water can be used as a primary product for other products which reduce the surface tension.

1. Basic water which is manufactured from a mixture of a lye and water and is chemically stable, characterized in that it is used as a drink, in particular as a readymade drink.

2. Basic water in accordance with claim 1 with the addition of one or more different aroma substances and/or colorings.

3. Basic water in accordance with claim 2 in which the added aroma substances are lemon aroma and/or orange aroma, rosewater aroma and/or other aroma substances.

4. Basic water in accordance with claim 1 in which the lye, which is admixed to the water, is manufactured by an electrolysis process, by a membrane electrolysis process, a batch process, or by a flow-through process.

5. Basic water in accordance with claim 4 in which the lye, which is added to water, is caustic soda lye (NaOH), caustic potash lye (KOH), or calcium hydroxide solution (Ca(OH)₂).

6. Basic water in accordance with claim 1 in which the water to which the lye is added is drinking water, table water, spring water, mineral water, melt water, rain water, tap water, osmosis water, or spa or medicinal water.

7. Basic water in accordance with claim 1 in which 1% to 99% lye is added to the water for the drink during the manufacture.

8. Basic water in accordance with claim 1 in which the admixed lye has a pH value of 7 to 14, preferably a pH value in the range from 8 to 10.

9. Basic drink, in particular readymade drink of basic water in accordance with claim 1, characterized in that it is suitable as a means for the de-acidifying and pH stabilization for humans and animals.

10. Use of the drink of basic water in accordance with claim 1 as a foodstuff, as a high-value food supplement medium, as a purification medium, or as a readymade drink.

11. Basic drink, in particular readymade drink of basic water in accordance with claim 1, characterized in that it is suitable as a hydration medium, as a mineralization medium and as a de-acidification medium for humans and animals.
